(19) United States
(12) Patent Application Publication
(10) Pub. No.: US 2008/0204428 A1
(43) Pub. Date: Aug. 28, 2008

(54) Multimodal Adaptive User Interface for an Electronic Device with Digital Branding Capabilities

(76) Inventors: Paul M. Pierce, Grayslake, IL (US); James E. Wicks, Lake Bluff, IL (US)

Correspondence Address: PHILIP H. BURRUS, IV, 460 Grant Street, Atlanta, GA, 30312, US

(21) Appl. No.: 11/836,616

(22) Filed: Aug. 9, 2007

Related U.S. Application Data
(60) Provisional application No. 60/891,742, filed on Feb. 27, 2007.

(51) Int. Cl. G06F 3/041

(52) U.S. Cl. 345/174; 345/34

(57) ABSTRACT

A multimodal device (100) includes a segmented optical shutter (204) that functions as a morphing user interface along the front surface (105) of the multimodal device (100). The morphing user interface is configured to present one of a plurality of mode-based actuators by selectively opening and closing segments (601,602,603,604) of the segmented optical shutter (204). Each set of mode-based actuators serves as a set of user actuation targets, or keys, for the multimodal device (100). In addition to the mode-based actuators, a brand mark (107,605,606) is presented, perhaps in a keypad region (106), that corresponds to hardware, software, or services that are operational on the multimodal device (100).

### CROSS REFERENCE TO PRIOR APPLICATIONS

This application claims priority and benefit under 35 U.S.C. § 119(e) from U.S. Provisional Application No. 60/891,742, filed Feb. 27, 2007.

### BACKGROUND

1. Technical Field

This invention relates generally to electronic devices having user interfaces, and more particularly to an electronic device having an interface configured to present a variety of mode-based keypad configurations to a user.

2. Background Art

Portable electronic devices, such as radiotelephones, digital cameras, and portable music players are becoming more and more prevalent. While in the past the corresponding functionality was unique to a particular device, many manufacturers are attempting to converge functionality of previously separate devices into a single device, while attempting to provide a converged experience, which does not compromise a user's experience in each of the different modes of operation. The many manufacturers are similarly trying to find ways to enhance the user's experience relative to each of previously disparate functions through the synergistic effects of a converged device. For instance, many mobile telephones today also include digital camera functions and text messaging functions. Some even include music playback functions.

It is not uncommon for device manufacturers and service providers to work together to deliver a multifunctional product, drawing upon and taking advantage of each of the participants expertise and experience relative to one or more of the various modes of operation. For example, a mobile phone manufacturer may work jointly with an on-line music service provider to offer a handset with both telephonic and music download/playback capabilities. Such a product will often be co-branded so that the user is aware of both companies' participation in the development. Advertisements may read “Check out the new MUZIK phone, manufactured by ABC Electronics and featuring music playback capability from XYZ Services.”

For truly multifunctional devices, such as a mobile phone with interactive gaming capabilities, camera and video capabilities, music download/playback capabilities, and navigation capabilities, a device manufacturer may work with several service providers. Each of these service providers may want to co-brand the device with the device manufacturer. Further, each service provider may want the user to actually know that their company is providing the services operating on the hardware. In short, each company wants the user to see their brand on the device.

One way to do this is to simply print the name of every contributing company on the side of the device. This solution, however, is fraught with problems. First, some real estate on the device, such as the front, user interface surface, is more valuable than the other. Companies may argue about which brand goes where. Second, the device becomes cluttered. With multiple brand marks on the device, the device itself may start looking like a stock car with logos placed everywhere. Further, as the devices become smaller, there is less and less space for a myriad of brand marks.

A second solution is to present a brand on the high-resolution display when a particular company's services are being used. Referring to the example above, when the MUZIK phone was in music playback mode, the XYZ Services brand may be presented on the high-resolution display. This solution is problematic, however, due to the size of the device. As noted above, most mobile telephones today are small. Most are small enough to fit in a shirt pocket. Correspondingly, the displays on these devices are sometimes limited and sometimes can measure 1.5 inches square or less. Where a user is watching a video, the visible video picture will be significantly reduced when a portion of the display is dedicated to displaying a brand alongside the other displayed elements more directly supporting the associated function. Furthermore, use of the display for displaying a brand, would require that the display be active in order to make visible the associated brand.

There is thus a need for an improved method of branding an electronic device.

### BRIEF DESCRIPTION OF THE DRAWINGS

FIG. 1 illustrates an electronic device having a shutter enabled dynamic keypad in accordance with one embodiment of the invention.

FIG. 2 illustrates an exploded view of one embodiment of a dynamic keypad interface in accordance with the invention.

FIG. 3 illustrates a sectional view of one embodiment of a dynamic keypad interface in accordance with the invention.

FIG. 4 illustrates an exploded view of a twisted nematic liquid crystal display in accordance with one embodiment of the invention.

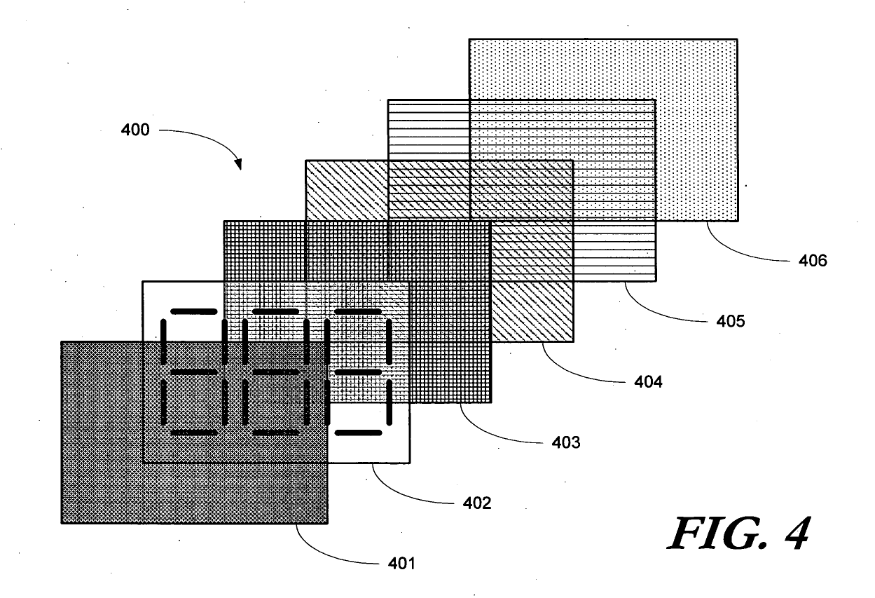

FIG. 5 illustrates an optical shutter in the opaque state in accordance with one embodiment of the invention.

FIG. 6 illustrates an exemplary segmented optical shutter having sample shutters open, or in the translucent state, in accordance with the invention.

FIG. 7 illustrates a segmented electroluminescent device in accordance with one embodiment of the invention.

FIG. 8 illustrates an exemplary multimodal device in an OFF or low-power state in accordance with one embodiment of the invention.

FIG. 9 illustrates an exemplary multimodal device in a navigation mode in accordance with one embodiment of the invention.

FIG. 10 illustrates an exemplary multimodal device in a telephone mode in accordance with one embodiment of the invention.

FIG. 11 illustrates an exemplary multimodal device in a music mode in accordance with one embodiment of the invention.

FIG. 12 illustrates an exemplary multimodal device in a gaming mode in accordance with one embodiment of the invention.

FIG. 13 illustrates an exemplary multimodal device in a camera mode, in a landscape orientation, in accordance with one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one under discussion. For example, talking about a device (10) while discussing figure A would refer to an element, 10, shown in figure other than figure A.

Copending, commonly assigned U.S. application Ser. No. 11/684,454, entitled “Multimodal Adaptive User Interface for a Portable Electronic Device”, teaches a multimodal electronic device that employs a segmented optical shutter enabled dynamic keypad for presenting one of a plurality of keypad configurations to a user by hiding and revealing user actuation targets. Each keypad configuration is presented by an optical shutter that opens or closes windows, which are configured as alphanumeric or device keys or symbols. The keypad configurations are, in one embodiment, modal, in that the keys presented are limited to only those needed for the particular mode of operation. As each mode of the device changes, the corresponding keypad configuration presented changes accordingly.

The present invention takes advantage of the optical shutter to present not only user actuation targets, but also electronic product co-branding. Specifically, embodiments of the present invention employ the segmented optical shutter to reveal and hide not only user actuation targets, but brand and logo information as well. The branding or logo information may correspond to a particular mode of the device. For example, where the device is in camera mode, and editing software in the device is provided by the KAMRA Photography Company, the KAMRA logo may be presented by the optical shutter to identify this fact to the user. Embodiments of the invention permit specific logos, brands, or marks to be hidden or revealed depending on the mode or function of device. These logos, brands, or marks may be selectively presented on the primary visual surface of the product without creating visual clutter.

Whereas prior art solutions used printing or labels to present branding information, the present invention offers advantages not matched by these prior art solutions. First, embodiments of the present invention permit a particular brand to be present only when the device is in a specific mode. Thereby hiding the brand when a service associated with the brand is not in use. Next, each brand may be presented in a larger and more predominant location along the device.

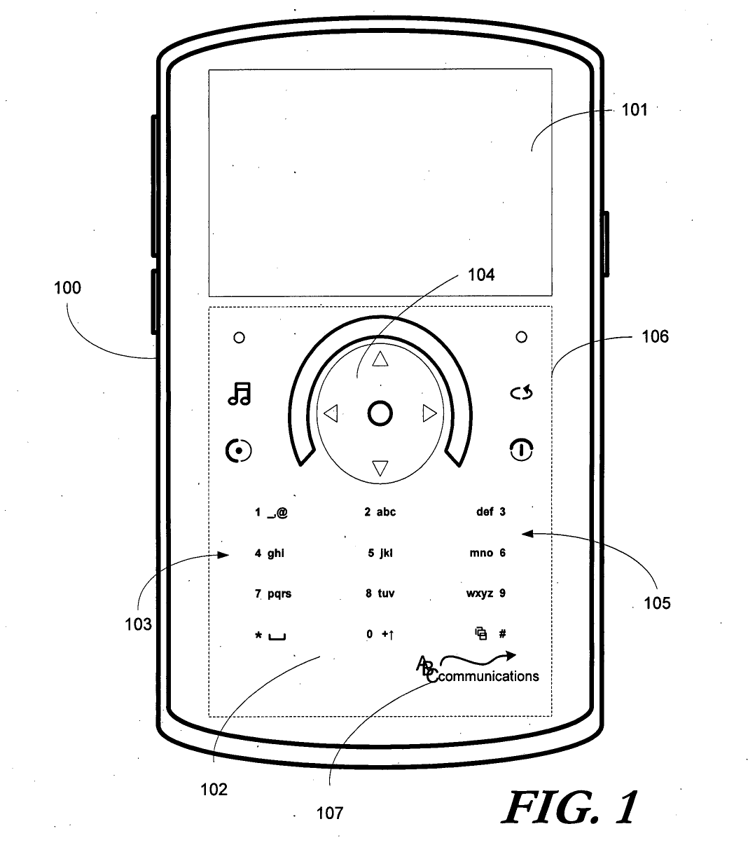

Turning now to FIG. 1, illustrated therein is portable electronic device 100 comprising a high-resolution display 101 and low-resolution display that is configured as a segmented optical shutter 102. The segmented optical shutter 102 is configured to present a mode-based dynamic keypad 103 and dynamic brand information 107 to a user. The exemplary embodiment shown in FIG. 1 also includes a navigation device 104—shown here as a set of navigational elements including a multidirectional navigation key and touch bar—disposed adjacent to the high-resolution display 101. In at least one embodiment, the touch bar extends at least partially around the multidirectional navigation key. The navigation device 104 is used, among other things, for navigating among different modes of the device 100.

The high-resolution display 101, which in one embodiment is a liquid crystal display (LCD), is configured to present device information to the user. The term “high-resolution display” is used herein to refer to a device that can present text and images to a user by altering a large number of individually addressable pixels which, when viewed collectively by a user, form the presented text or image. The high-resolution display 101 is used for the presentation of text, information, and graphics on a mobile device with sufficient granularity as to be easily switched between graphics or text. For example, the high-resolution display 101 would be one suitable for presenting an image in the Joint Photographics Expert Group (JPG) format to the user. Such displays generally are configured to turn on and off individual pixels by way of a display driver for the presentation of high-resolution information. Examples include a 256 pixel by 128 pixel reflective or backlit LCD. Exemplary high-resolution display devices are manufactured by Samsung and Sony.

The front surface 105 of the device 100 forms the overall user interface. In a keypad region 106, the segmented optical shutter 102 provides a dynamic user input interface. This dynamic user interface is configured to present different indicators, which may appear as keys or actuation targets, across the user interface in the keypad region 106. The dynamic brand information 107 may also be presented in the keypad region 106. The dynamic brand information 107 may also be placed outside the keypad region 106, but is generally placed in areas other than the high resolution display 101 so as not to interfere with a user's view of the information presented on the high resolution display.

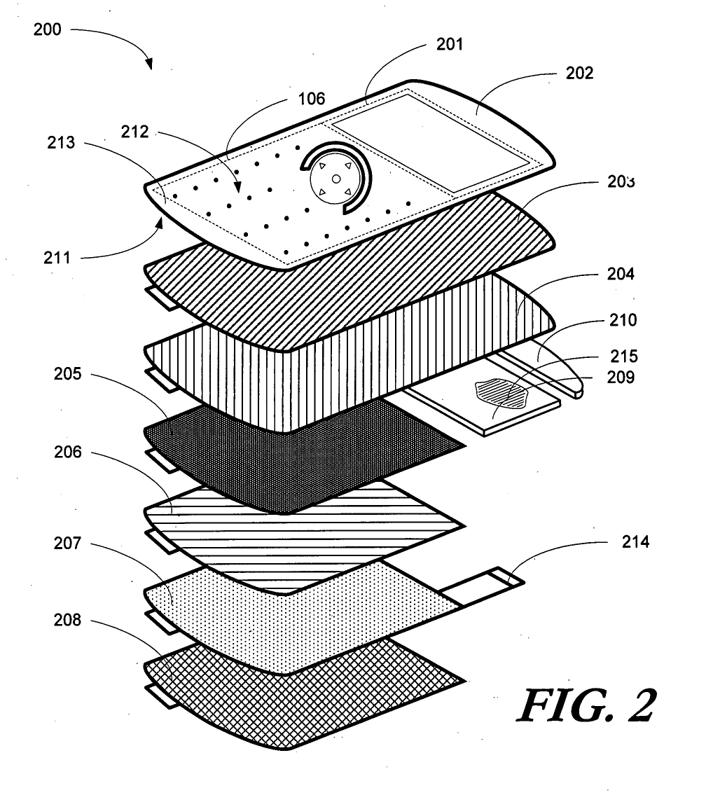

Turning now to FIG. 2, illustrated therein is an exploded view of a dynamic user interface 200 for a portable electronic device (100) in accordance with one embodiment of the invention. The user interface 200 includes a dynamic keypad region 106 and a display region 201. The user interface 200 is made from several layers, each layer implementing a different function. While several layers are shown, it will be clear to those of ordinary skill in the art having the benefit of this disclosure that each and every layer may not be required for a specific application. By way of example, the capacitive sensor 203 may not be needed for all devices. The structure of FIG. 2 is exemplary.

The exemplary user interface 200 of FIG. 2 includes the following components: a cover layer 202; a capacitive sensor 203; a segmented optical shutter 204; a segmented electroluminescent device 205, a resistive switch layer 206; a substrate layer 207; and a tactile feedback layer 208. Additionally, a high-resolution display 209 and filler materials 210 may be included to complete the assembly. While the layers are shown individually, it will be clear to those of ordinary skill in the art having the benefit of this disclosure that some of the various layers may be combined together. For instance, the cover layer 202 and capacitive sensor 203 may be integrated together to form a single layer. Similarly, the tactile feedback layer 208 may be integrated into the cover layer 202, and so forth.

Starting from the top with the cover layer 202, a thin film sheet serves as a unitary fascia member for the device (100). A “fascia” is a covering or housing, which may or may not be detachable, for an electronic device like a mobile telephone. While the drawings herein employ a mobile telephone as an exemplary electronic device for discussion, it will be clear to those of ordinary skill in the art having the benefit of this disclosure that the invention is not so limited. The fascia of the present invention could be used for any electronic device having a display and a keypad, including gaming devices, personal digital assistants, pagers, radios, and portable computers.

The cover layer 202, in one exemplary embodiment, is a thin, flexible membrane. Suitable materials for manufacturing the thin, flexible membrane include clear or translucent plastic film, such as 0.4 millimeter, clear polycarbonate film. In another embodiment, the cover layer 202 is manufactured from a thin sheet of reinforced glass. The cover layer, being continuous and without holes or other apertures or perforations, is well suited to serve as a fascia for the device (100), as it prevents dust, debris and liquids from invading the device. While the cover layer 202 is continuous, for discussion purposes, the cover layer 202 will be colloquially sectioned into a keypad region 106 and a display region 201. The keypad region 106 is the section of the cover layer 202 where user actuation targets, keys, and buttons will be presented, while the display region 201 is the section of the cover layer 202 where the high-resolution display 209 is visible.

To provide ornamentation, text, graphics, and other visual indicators, the cover layer 202, in one embodiment, includes printing disposed on the rear face 211. In one embodiment of the invention, the segmented optical shutter layer 204 provides graphics and color for the front surface (105) of the device (100). However, even in such an embodiment, selective printing on the cover layer may be desirable. For instance, printing may be desired around the perimeter of the cover layer 202 to cover electrical traces connecting the various layers. Additionally, printing of select demarcations 212 may be desirable. As will be described below, in one embodiment, when the device is off, the front surface (105) goes completely blank. Demarcations 212, which may be very light, small circles, provide the user with an indication of which portion of the front surface (105) is the keypad region 106, and which portion is the display region 201.

Printing may be desired on the front face 213 for various reasons as well. For example, a subtle textural printing or overlay printing may be desirable to provide a translucent matte finish atop the device (100). Such a finish is useful to prevent cosmetic blemishing from sharp objects or fingerprints. By printing only on the rear face 211, however, the front face 213 can remain smooth and glossy. When printing is done on the rear face 211 of the cover layer 202, the printing, being disposed on the inside of the device, is protected from wear and abrasion. There is generally no printing in the display region 201, so the high-resolution display 209 may be easily viewed. Printing about the display region 201 may be desired, however, for the reasons listed above.

The cover layer 202 may also include an ultra-violet barrier. Such a barrier is useful both in improving the visibility of the high-resolution display 209 and in protecting internal components of the device (100).

The exemplary user interface 200 of FIG. 2 also includes a capacitive sensor 203. The capacitive sensor 203, which is formed by depositing small capacitive plate electrodes on a substrate, is configured to detect the presence of an object, such as a user's finger, near to or touching the user interface 200. Control circuitry within the device detects a change in the capacitance of a particular plate combination on the capacitive sensor 203. The capacitive sensor 203 may be used in a general mode, for instance to detect the general proximate position of an object relative to either the keypad region 106 or the display region 201. The capacitive sensor 203 may also be used in a specific mode, where a particular capacitor plate pair may be detected to detect the location of an object along length and width of the front surface (105) of the device (100). In this mode, the capacitive sensor 203 may be used to detect the proximate position of an object, such as a user's finger, relative to any of the actuation targets presented.

Turning to the segmented optical shutter 204, this layer is a segmented display device configured with a plurality of windows, or “shutters.” A “segmented” display device is used herein to mean a display device with less granularity than the pixilated display device referred to above. The segmented display device is capable of actuating a predefined segment or segments to open a shutter so as to present a predetermined text or symbol graphic to a user, but does not have sufficient granularity to easily transition from, for example, text to graphics. The segmented optical shutter 204 may be thought of as a low-resolution display. The term “low-resolution” is used herein to differentiate the segmented display device of the segmented optical shutter 204 from the high-resolution display 209. While the high-resolution display 209 is configured to actuate individual pixels to present high resolution text or images, the low-resolution display of the segmented optical shutter 204 uses electrodes placed atop and beneath the segmented optical shutter 204 to open and close windows, thereby transforming the window from a first, opaque state to a second, translucent state. The segmented optical shutter 204 is “segmented” because individual windows, or shutters, may be controlled independently. Further, as will be seen in more detail below, by configuring the electrodes on one side of the segmented optical shutter 204, each shutter can be configured as the alphanumeric indicia, which may include numbers, letters, symbols, or brand information.

The configuration of user actuation targets and brand information may be mode-based. This means that the keypad configuration corresponds to a particular mode of operation of the device (100). For example, a camera mode may correspond to a camera keypad configuration and camera company brand, while a phone mode may correspond to a phone configuration and phone company brand. The segmented optical shutter 204 presents each of the plurality of keypad configurations by transitioning segments of the segmented optical shutter 204 from opaque states to translucent states. A segmented electroluminescent device 205 may then project light to illuminate the corresponding segment by projecting light through the segment.

The segmented electroluminescent device 205 includes segments that operate as individually controllable light elements. These segments of the segmented electroluminescent device 205 may be included to provide a backlighting function to create the user actuation targets or illuminated brand information. As used herein, “electroluminescent” refers to any device capable of producing luminescence electrically, including light emitting diodes, and equivalent devices. In one embodiment, the segmented electroluminescent device 205 includes a layer of backlight material sandwiched between a transparent substrate bearing transparent electrodes on the top and bottom. The electrodes reside beneath a corresponding shutter of the segmented optical shutter 204.

The high resolution display 209, which may have its own lighting system and may also include a polarizing layer 215 configured to polarize light along an axis of polarization, may be placed adjacent to the segmented electroluminescent device 205. Further, filler material 210 may be included to complete the assembly.

The resistive switch layer 206 serves as a force switch array configured to detect contact with any of one of the shutters dynamic keypad region or any of the plurality of actuation targets. An “array” as used herein refers to a set of at least one switch. For instance, where the cover layer 202 is manufactured from glass, one switch may be all that is necessary. However, when the cover layer 202 is manufactured from thin film plastic, multiple switches may be employed. The array of resistive switches functions as a force-sensing layer, in that when contact is made with the front surface (105), changes in impedance of any of the switches may be detected. The array of switches may be any of resistance sensing switches, membrane switches, force-sensing switches such as piezoelectric switches, or other equivalent types of technology.

A substrate layer 207 is provided to carry the various control circuits and drivers for the layers of the display. The substrate layer 207, which may be either a rigid layer such as FR4 printed wiring board or a flexible layer such as copper traces printed on a flexible material such as Kapton®, can include electrical components, integrated circuits, processors, and associated circuitry to control the operation of the display. The substrate layer 207 includes a connector 214 for coupling to other electrical components within the device (100).

In one embodiment of the display assembly 200, for example where the cover layer 202 is manufactured from glass, a modicum of cover layer deflection is all that is required to actuate one of the keys presented by the segmented optical shutter 204 and the segmented electroluminescent device 205. This deflection can be on the order of tens of micrometers. As such, a user may not physically perceive any deflection at all when pressing each key.

To provide tactile feedback, an optional tactile feedback layer 208 may be included. The tactile feedback layer 208 may include a transducer configured to provide a sensory feedback when a switch on the resistive switch layer detects actuation of a key. In one embodiment, the transducer is a piezoelectric transducer configured to apply a mechanical “pop” to the user interface 200 that is strong enough to be detected by the user. Thus, the tactile feedback layer provides sensory feedback to the user, thereby making the smooth, substantially planar user interface 200 react like a conventional keypad without the need of individual popple-enabled keys protruding through the keypad.

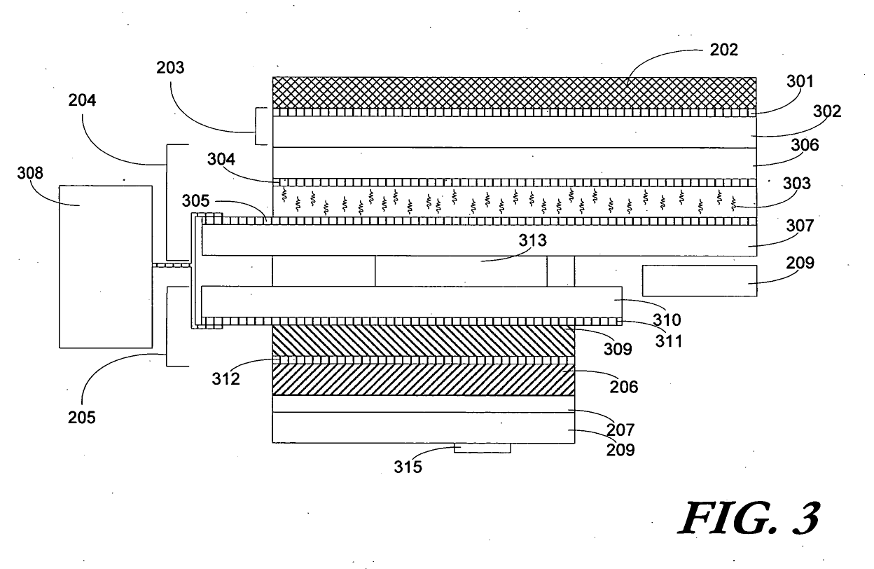

Turning now to FIG. 3, illustrated therein is a side view of the user interface (200) shown in FIG. 2. Each layer may be seen from the side in a cut-away view. Again, it will be clear to those of ordinary skill in the art having the benefit of this disclosure that the invention is not limited to the specific structure shown in FIG. 3. Some layers, as noted above, are optional and may not be included in certain applications.

Note that the layers may be coupled together in any of a variety of ways. One exemplary embodiment of a coupling mechanism is by using a thin layer of clear (transparent), non-conductive adhesive. For instance, the cover layer 202, the capacitive sensor 203, and the segmented optical shutter 204 may each be mechanically coupled together with non-conductive, translucent adhesive. This coupling keeps the overall assembly properly aligned within the device.

When viewing from the top, a user first sees the cover layer 202. Where glass is used for the cover layer 202, reinforced glass is often preferred to provide additional reliability to the user interface (200). The glass may be reinforced by a strengthening process, such as a chemical or heat treatment process.

Next, the capacitive sensor 203 may be seen. The capacitive sensor 203 includes both an electrode layer 301 and substrate layer 302. The substrate layer 302, which may be either rigid, or soft (for instance a silicone layer), carries the electrode plates that form the capacitive sensors. The electrodes may be used in a singular configuration, or in pairs. Further alternate electrode pairs, including electrode groupings of two, four, or six electrodes, may be used to form the capacitive sensors. The electrode layer 301, as will be described in more detail below, may be formed by printing solid indium-tin oxide (In.sub.2 O.sub.3—SnO.sub.2) in the desired capacitor plate patterns atop the substrate layer 302. Other materials, including patterned conductive inks, may also utilized in the electrode construction.

Next, the segmented optical shutter 204 may be seen. In one embodiment, the segmented optical shutter 204 is manufactured using a twisted nematic liquid crystal display material. This material is discussed herein as an exemplary embodiment; it will be clear to those of ordinary skill in the art having the benefit of this disclosure that the invention is not so limited. Other materials, including polymer-dispersed liquid crystal material, super twisted nematic liquid crystal material, ferro-electric liquid crystal material, electrically-controlled birefringent material, optically-compensated bend mode material, guest-host materials, and other types of materials using the same or other types of light modulating may also be used.

The segmented optical shutter 204 is made from a twisted nematic liquid crystal display material 303 that is sandwiched between two electrodes 304,305 and two substrates 306,307. The electrodes 304,305 and substrates 306,307 are preferably transparent, such that light can pass freely through each. The substrates 306,307 may be manufactured from either plastic or glass. The upper electrode 304 is constructed, in one embodiment using indium-tin oxide affixed to substrate 306. The lower electrode 305 is constructed using a patterned indium-tin oxide layer affixed to the lower substrate 307. In one embodiment, the patterns are those of alphanumeric keys, symbols, or brand information representing keys, user actuation targets, or sources of goods and services related to the device.

The patterned electrode(s) 305, by way of patterned electrical traces, is connected to a control circuit 308. The control circuit 308 applies a field to the patterned electrode(s) 305, while the other electrode 304 acts as a ground. The direction of the electric field is not important to the segmented optical shutter 204, thus either electrode can act as the ground.

The electric field applied alters the light transmission properties of the twisted nematic liquid crystal display material 303. The electric field can cause sections under each of the patterned electrodes 305 to transition from a first state to a second state. By way of example, the first state may be opaque, while the second state is translucent. The patterns of the patterned electrodes 305 define the images of each shutter in the optical shutter. By way of example, a shutter can be patterned as a “9 key” for a phone by patterning one electrode as the “9 wxyz” characters. Similarly, a shutter may be patterned as a brand mark for the ABC Communications Co. trademark. The shutters then act as “windows” that can be open or closed, to reveal or hide images.

The segmented optical shutter 204 may also include one or more polarizing layers disposed atop and beneath the optical shutter. These polarizing layers, which are used in twisted nematic liquid crystal devices as will be shown below, polarize light along a polarization axis.

The segmented electroluminescent device 205 includes a layer of electroluminescent material 309 sandwiched between a transparent substrate 310. The transparent substrate 310 is patterned with indium tin oxide electrodes, in one embodiment, each forming the actuator for an electroluminescent element. The electroluminescent elements are positioned beneath a corresponding segment of the segmented optical shutter 204. The plurality of patterned electrodes 311 of the segmented electroluminescent device 205 are aligned with the various shutters of the segmented optical shutter 204, generally on a one-to-one basis. In such an embodiment, the ground electrode 312 may comprise a solid conductive ink layer printed on the bottom surface of the electroluminescent material 309; however, the ground electrode 312 may be patterned and may be borne on a transparent or non-transparent substrate if desired. One electrode layer 301 is connected to control circuitry 308. Like the segmented optical shutter 204, either electrode layer 311,312 can act as the ground. Each electroluminescent element is active when the corresponding segmented optical shutter segment is in a translucent state.

In one embodiment, the segmented electroluminescent device 205 may further include a transflector layer. The transflector layer, which is a semi-transparent material configured to both reflect light and pass light, permits the operation of the device (100) in a transflexive mode. In the transflexive mode, when any shutter of the segmented optical shutter 204 opens, incident light passes through the shutter, reflects off the transflector layer, and is passes back to the user. This action makes the alphanumeric indicia of the segmented optical shutter layer visible in bright light conditions. When the segmented electroluminescent device 205 is operational, which may be dictated by an ambient light sensor, the transflector passes light from the electroluminescent device through the open shutters so as to form an actuation target that includes both the alphanumeric indicia and the virtual key created by the projection of light through the segmented optical shutter 204. This action makes the actuation targets visible in low light conditions.

An optional color layer 313 may be included atop the segmented electroluminescent device 205 having one or more colors. The color layer 313, which may also be a transflector having both transmission and reflection properties, may be used to color light coming from the segmented electroluminescent device 205. The color layer 313 may alternatively be made of color filters, which only have transmission properties.

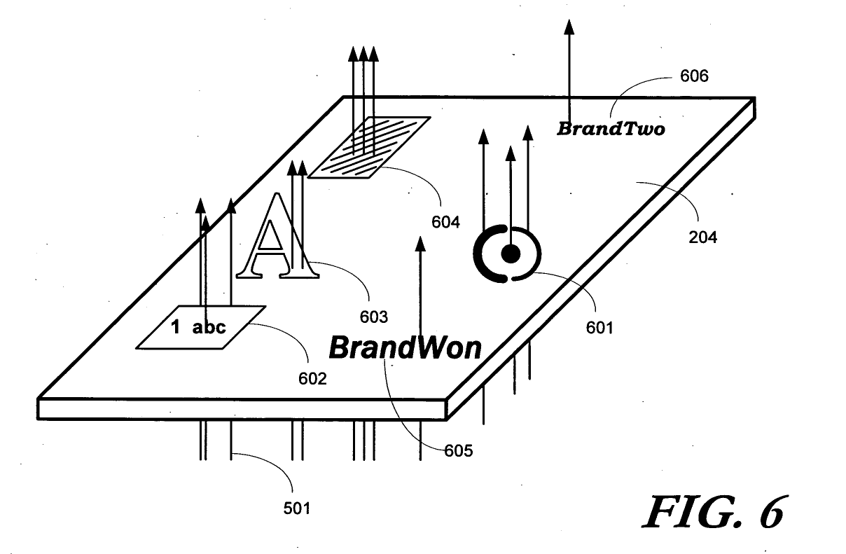

Turning now to FIG. 6, illustrated therein is an exploded view of a twisted nematic liquid crystal display device 400. The device 400, which in one embodiment is used to form the segmented optical shutter (204), is referred to as “twisted” because it contains liquid crystal elements that twist and untwist in differing amounts to allow light to pass through.

A first polarizer 401 is disposed on one side of the device to polarize incident light. A substrate 402, having indium tin oxide electrodes (as previously discussed) printed in varying shapes is disposed adjacent to the polarizer. The electrodes may be disposed in shapes that correspond to the alphanumeric indicia or symbols associated with the keys of the electronic device (100).

Twisted nematic liquid crystal material 403 is then next, followed by another substrate 404 configured with ground electrodes. A horizontal filter 405 then is used to permit and block light. A reflective or transflective surface 406 then reflects light back (in a reflective mode) or transmits light in a transflective mode. The reflective or transflective surface 406 is optional and will depend upon the particular application. When the twisted nematic liquid crystal device is used as an optical shutter, the reflective or transflective surface 406 may not be employed.

Where no voltage is applied to the electrodes, the device is in a first state. When voltage is applied the liquid crystal material twists—in incremental amounts up to 90 degrees—thereby changing the luminous polarization. This liquid crystal thus acts as a controllable polarizer, controlled by electrical signals applied to the electrodes. Adjustment of the voltage being applied to the electrodes permits varying levels grey, as well as transparent states or opaque states to be created.

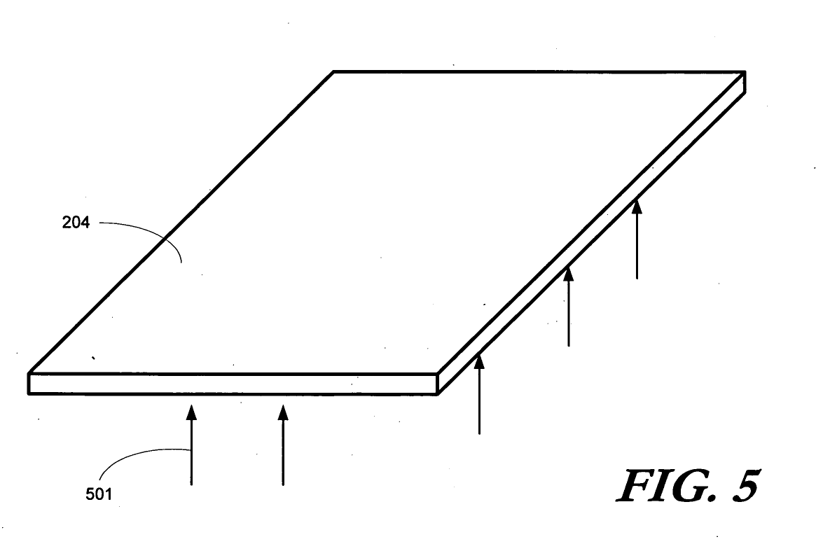

Turning now to FIG. 5, illustrated therein is the segmented optical shutter 204 in an opaque state. Incident light 501 is generally not permitted to pass through the optical shutter, as the liquid crystal material is twisted, relative to the polarizers, so as to block light from passing through.

Turning now FIG. 6, illustrated therein is the segmented optical shutter 204 when various exemplary shutters 601,602,603,604,605,606 have been transitioned from the opaque state to the translucent state. Control circuitry, which may be disposed on the substrate layer 207, is configured to selectively actuate at least one shutter or cell, perhaps based upon a current operational mode of the device (100), to transform the shutter from a first cell state to a second cell state.

Each shutter, which acts as a segment within the segmented optical shutter 204, corresponds to a key, symbol, or brand, and functions as a window. One such window may be a window disposed above the high resolution display (209). When any of the segments is actuated, the key, symbol, brand, or object beneath the window becomes visible to a user. Incident light 501 passes through the shutters 601,602,603,604,605,606 thereby making the shape of the shutter visible. By way of example, where the device (100) includes a segmented electroluminescent device (205), light 501 from the electroluminescent device may project through the shutters 601,602,603,604,605,606 when they are open. This is generally identified as operation in a transmissive mode. The segmented electroluminescent device (205) may be configured to only operate in low ambient light conditions. Where the device (100) includes a transflector, light may pass through each shutter 601,602,603,604,605,606, reflect off the transflector, and pass back through each shutter 601,602,603,604,605,606. This is generally identified as operation in a transflective mode.

The exemplary shutters 601,602,603,604,605,606 of FIG. 6 have been geometrically configured as particular keys, symbols, brand information, or windows for the portable electronic device. These keys, symbols, windows and brand information are exemplary only, as it will be clear to those of ordinary skill in the art having the benefit of this disclosure that many different shapes and sizes are possible without departing from the beneficial teachings of the present application. Some shutters 601,602,603,604 form user actuation targets by transitioning from the first (opaque) state to the second (transparent) state. Others hide and reveal brand information by transitioning from the opaque state to the transparent state.

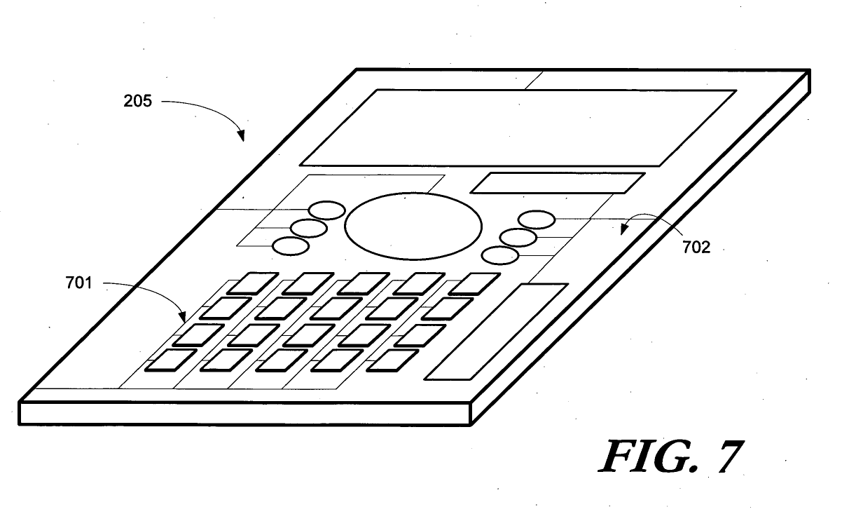

Turning now to FIG. 7, illustrated therein is one embodiment of a segmented electroluminescent device 205 in accordance with at least some embodiments of the present invention. The segmented electroluminescent device 205 includes patterned electrodes 701 that are positioned to correspond to the shutters of the segmented optical shutter (204). By using patterned electrodes 701, light segments may be selectively actuated. In other words, when the each shutter is actuated to transition from an opaque state to a translucent state, a corresponding patterned electrode, and thus a corresponding electroluminescent cell, is actuated so as to project light through the actuated segment. This is in contrast to an electroluminescent device having a single electrode or a comprehensive ON state. By actuating selective patterned electrodes 701, only those corresponding to open shutters are actuated, thereby reducing overall power consumption of the device (100).

The segmented electroluminescent device 205 may also include a reflective or transflective layer 702 coupled thereto. For instance, the reflective or transflective layer 702 may be disposed on the top of the segmented electroluminescent device 205. As such, the segmented electroluminescent device 205 may operate in a reflective mode when the luminescent device is inactive, and in a transflective mode when the luminescent device is active. In addition to using electro luminescent materials for the segmented electroluminescent device 205 as previously described, other materials, including light emitting diode arrays, plasma panels, vacuum florescent panels, organic or polymeric light emitting diode panels, or other light source materials may also be used.

One feature of embodiments of the present invention is that of hiding and revealing brand information. When the device is in a low-power mode, all keypad region information may be hidden. When the device is returned to the operational state, and navigated to a particular mode, the dynamic user interface of the device presents a keypad configuration and brand information to the user. Said differently, the dynamic user interface surface of the multimodal device is configured to be blank when the multimodal device is in a first state (such as a low-power or sleep mode) and is configured to present a set of mode base actuators and indicia to a user by selective actuation of segments of the segmented optical shutter. Some of the indicia may include a brand mark.

The brand mark may be associated with an operational hardware or software component of the device. Likewise, the brand mark may also be associated with a service delivered to or through the device. The brand mark may correspond to a vendor. By way of example, where a software-based feature set is provided by a software vendor, the brand mark may correspond to that vendor. More specifically, the brand mark may represent a logo, company name, slogan, trademark, or other indicia corresponding to the software vendor. As the feature set changes, the vendor and the corresponding brand mark may also change. Some brand marks may be continually accessible. For example, where the device is a radiotelephone, the brand mark may correspond to a radiotelephone service provider. Such a mark may be continually accessible, or may be presented only when the radiotelephone is in telephone mode.

While embodiments of the invention may be applied to any of a number of different devices, the exemplary device shown in the figures that follow will be a radiotelephone that includes the following modes of operation: a radiotelephone mode, a navigational mode, a gaming mode, a music player mode, a video player mode, a picture display mode, a text capture mode, a picture capture mode, or a video capture mode. It will be clear to those of ordinary skill in the art having the benefit of this disclosure that other modes, subsets of these modes, and alternate combinations of subsets of these modes may be used. The identification of possible modes are exemplary only.

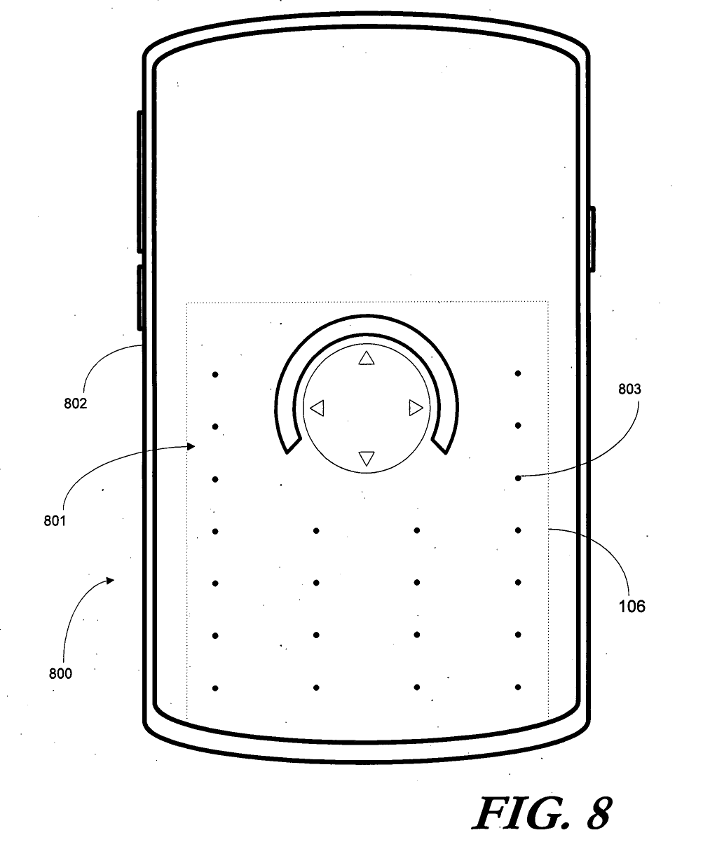

Turning now to FIG. 8, illustrated therein is the exemplary multimodal device 800 when in the OFF mode. (The embodiment of FIG. 8 may also arise when the multimodal device 800 is in a low power or sleep mode.) When the segmented optical shutter (204) traverses both the keypad region 106 and the high resolution display, the dynamic user interface surface 801 of the multimodal device 800 will be blank when the device is in this state. This occurs because each of the shutters is closed (i.e. in the opaque state), thereby prohibiting visibility of any of the keys, symbols, brand information, or the high-resolution display. Thus the keypad region is blank, as is the high-resolution display area. In one embodiment, the multimodal device 800 has a colored housing 802. The color of the housing 802 may be chosen to be complimentary or substantially similar to the color of the dynamic user interface 801 when the shutters are closed, so that the device in the OFF or low-power mode is smooth, uniform, and of a single or complimentary colors.

As the device in the off mode or low-power mode may have a dynamic user interface 801 that is completely blank, in one embodiment it is helpful to include indicia of the keypad region so that the user knows approximately where the different keypad configurations corresponding to different operational modes of the mobile device will appear across the dynamic user interface 801. In the multimodal device 800, these indicia are provided by small surface demarcations 803 that appear across the substantially planar surface of the dynamic user interface 801. The surface demarcations 803, which may be applied by printing non-conductive ink on the cover layer (202), may be arranged in columns and rows as shown in FIG. 8. Specifically, in one embodiment, the surface demarcations 803 are arranged in three columns and four rows. When low resolution display optical shutter (204) creates a particular set of user actuation targets by transitioning one or more shutters to the open state by selective actuation of the low resolution display, the various key indicators are dynamically presented between the surface demarcations 803.

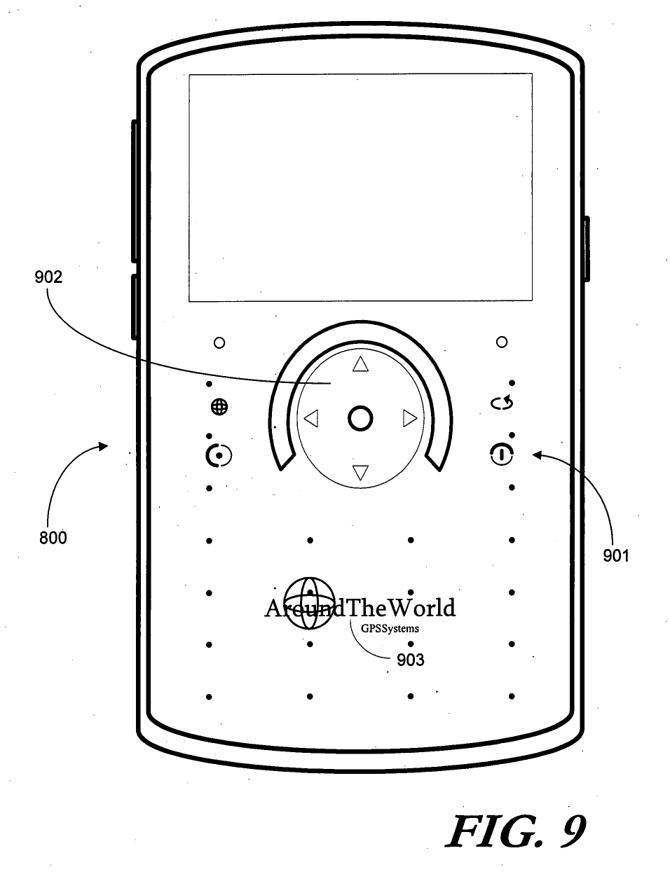

Turning now to FIG. 9, illustrated therein is the multimodal device 800 having changed from the OFF or low power mode of FIG. 8 to a navigation mode. The multimodal device 800 may be converted from the OFF or low power mode to an alternate mode in one of a variety of ways. A first method, as noted above, is for a user to actuate the proximity sensor. A second method, discussed in more detail below, is from an external event. When transitioning from the OFF or low power mode, the multimodal device 800 awakens at least one display segment of the segmented optical shutter device transitions to the translucent state. This occurs when the exemplary multimodal device is ON. One keypad configuration and the high-resolution display become visible to the user.

In the navigation mode of FIG. 9, the multimodal device 800 presents the navigation keypad configuration 901. The keypad configuration includes at least one brand mark 903. In the embodiment of FIG. 9, the brand mark 903 includes the name of an hypothetical global positioning systems service provider affiliated with the navigation software operating on the multimodal device 800 when the multimodal device 800 is in the navigation mode. The user may use the navigation mode, for example, perhaps with the assistance of the global positioning system, to determine a present location and to obtain directions to another location. The keypad configuration 2001 associated with the navigation mode is limited to only the buttons needed for this particular mode, combined with the brand information presented by the brand mark 903. The brand mark 903 may be multicolored. A navigation device 902 is present, both for navigation to another mode and for scrolling through the different views associated with the navigation mode.

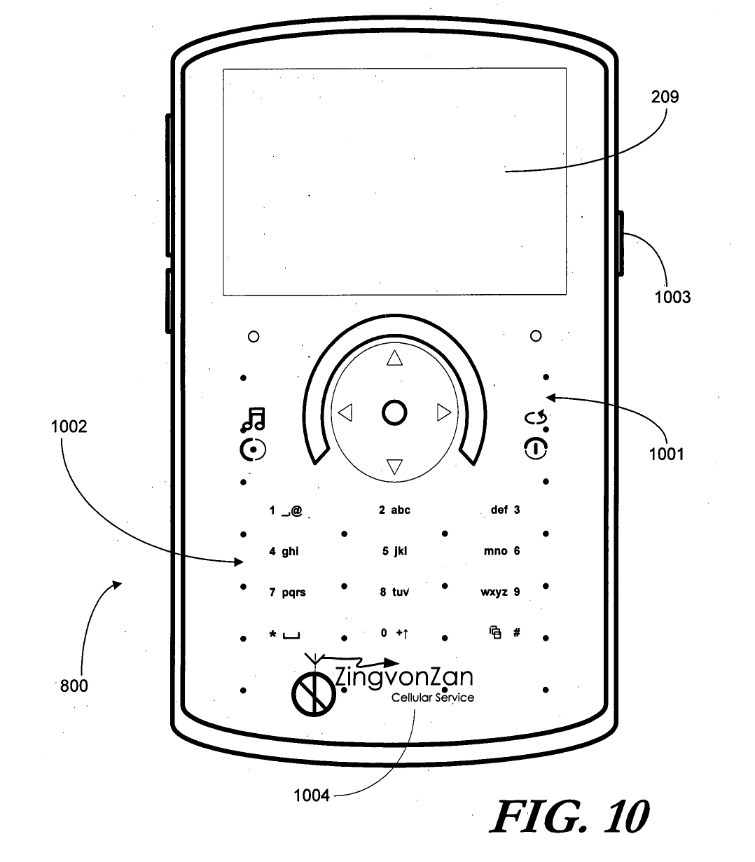

Turning now to FIG. 10, illustrated therein is the telephone mode, or radiotelephone mode. In the telephone mode, used for voice communication, the multimodal device 800 has transitioned such that different indicators are dynamically presented along the dynamic user interface surface 1001 by optical shutters. In particular, the multimodal device 800 has transitioned such that the shutters have presented a traditional telephone keypad 1002 and a brand mark 1004 representing a radiotelephone service provider. The traditional telephone keypad 1002 includes number keys 1-9 and 0, as well as send and receive keys. The traditional telephone keypad 1002 is presented in a portrait configuration.

One particular feature of note in the telephone mode, taking advantage of the capacitive sensor (203) is a power saving option. When the device is in the telephone, or voice communication, mode, and the multimodal device 800 is held to the user's head, the capacitive sensor (203) may detect the presence of the user's face near the substantially planar user interface surface 1001. In such a scenario, upon receiving a signal from control circuitry coupled to the capacitive sensor (203), the high resolution display 209 transitions to a low power mode, which may include shutting down the high resolution display 209. This occurs when the proximity sensor detects an object such as the user's face within a predetermined distance of the high-resolution display 209. This feature reduces overall power consumption, thereby extending the life of the battery within the multimodal device 800.

As noted above, the present operating mode of the device can be changed in a variety of ways. This includes touching the device or coming within a predetermined distance of the proximity detector. An alternate method of changing modes stems from an external event. For instance, when the device is in an alternate mode, such as the gaming or picture capture mode, and an incoming call from a remote source is received, the multimodal device 800 may automatically transition into the telephone mode so that the user may accept the incoming call. Other external events from remote sources include an incoming text message, an incoming multimedia message, or an incoming data transmission. Each of these events, in one embodiment, may cause the device to transition from one mode to another.

Further, the active mode of the multimodal device 800 may be changed by a device event. Such events include the actuation of dedicated buttons 1003 that may be disposed on the sides of the device. Other device events may include a low battery, device error, or low memory warning, each of which may cause the operating mode of the device to transition.

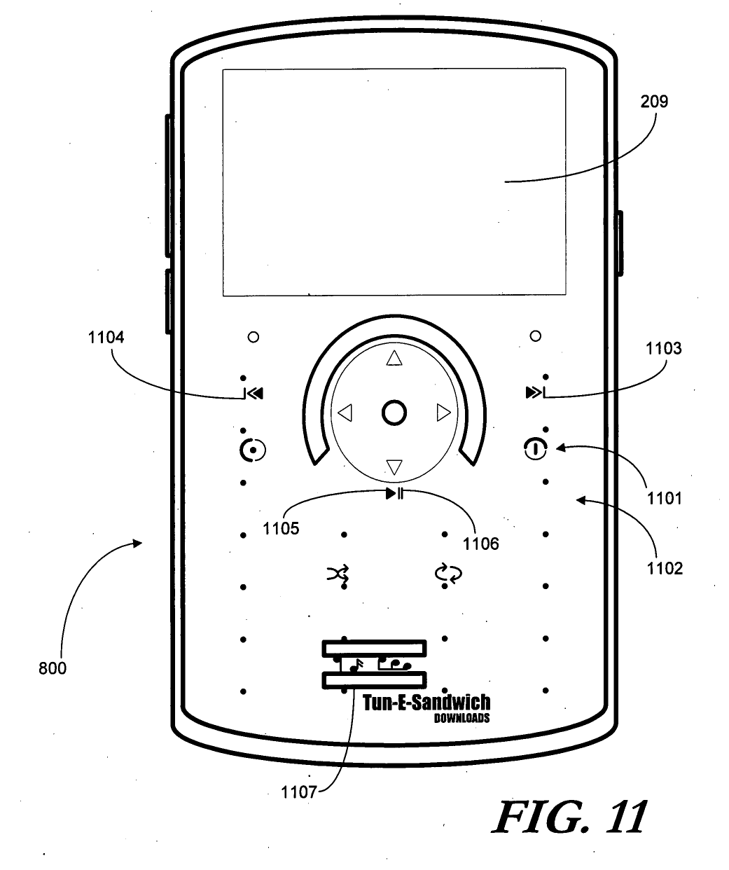

Turning now to FIG. 11, illustrated therein is the multimodal device 800 in the music or multimedia playback mode. In one embodiment of the device, the device is configured to store and playback music, video, or other multimedia content. In such a mode, the low-resolution optical shutter (204) is configured to present actuation targets 1101 and brand marks 1107 along the user interface 1102 that correspond to the music mode. Such actuation targets 1101 may include at least a fast forward button 1103, a rewind button 1104, a play button 1105 and a pause button 1106. The brand mark 1107 may be that of an electronic multimedia content vendor.

In one embodiment of the device, these music mode buttons may be presented in multiple orientations relative to the high-resolution display 209. As the dimensions of the high-resolution display may not be square, viewing some images may be more desirable in a landscape mode, where the device is held sideways. To accommodate such situations, in one embodiment the fast forward button 1103, the rewind button 1104, the play button 1105, and the pause button 1106 may be presented in a portrait mode relative to the high-resolution display, i.e. a mode where the device is disposed in the upright position. Alternatively, the fast forward button 1103, the rewind button 1104, the play button 1105 and the pause button 1106 may be presented in a second orientation, the landscape orientation, in an alignment that is transverse to the first orientation, for the landscape mode of the high resolution display 209.

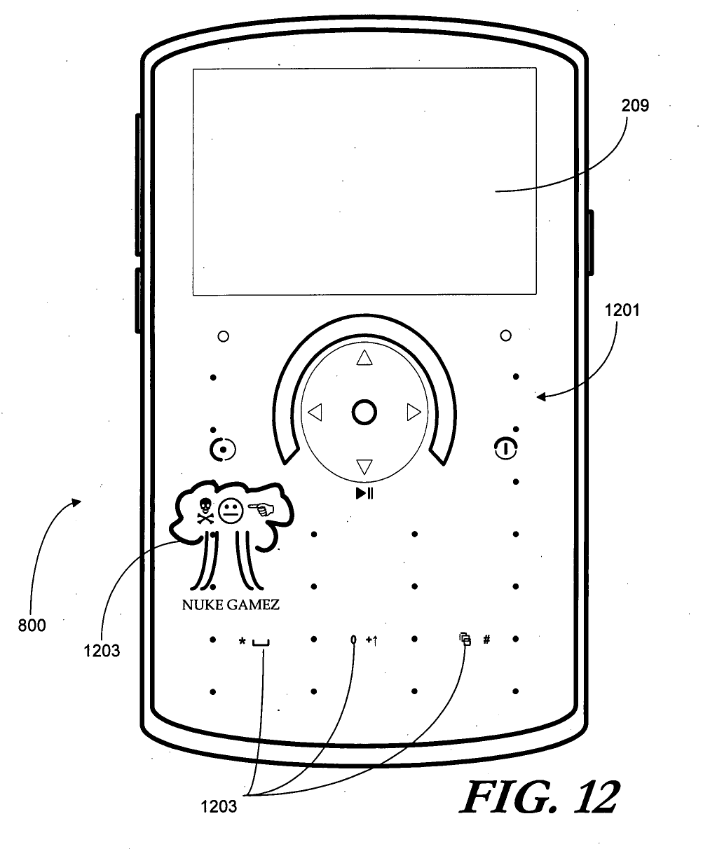

Turning now to FIG. 12, illustrated therein is the multimodal device 800 in the gaming mode. In the gaming mode, the keypad configuration 1201 may be presented in a portrait orientation relative to the high-resolution display 209. In the gaming mode, a rudimentary set of keys, combined with a brand mark 1203 that may correspond to an electronic game vendor, may be all that is required. Other keys, including the directional keys associated with the navigation mode, may also be used. Game action keys 1202 may be disposed at the base of the device.

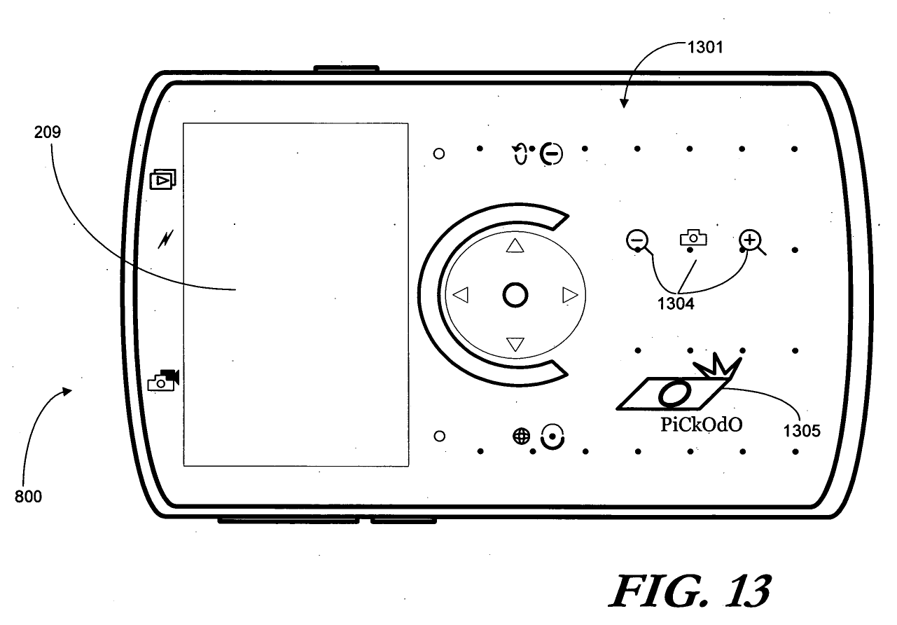

Turning now to FIG. 13, illustrated therein is the multimodal device 800 in a photo or video capture mode, also known as a camera mode. In the camera mode, the particular keypad configuration 1301 is presented in a landscape mode relative to the high-resolution display 209. In the landscape orientation, select camera-operating keys 1304 are presented in an orientation that is transverse with respect to the keypad configuration orientations of FIGS. 10-12. The camera, which may be positioned on the rear surface of the multimodal device 800, takes pictures while the pictures are displayed on the high-resolution display. A brand mark 1305, corresponding to a camera application vendor, may also be presented.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A multimodal device comprising a dynamic user interface surface configured to be blank when the multimodal device is in a first state, and when in a second state the dynamic user interface surface is configured to present a set of mode based actuators and indicia by selective actuation of segments of a low resolution display, wherein the set of mode based actuators and indicia comprises at least one non-pixelated selectively presented brand mark corresponding to at least one of the modes.

2. The multimodal device of claim 1, wherein the set of mode based actuators is limited to those needed for a present mode of operation of the multimodal device.

3. The multimodal device of claim 2, wherein the present mode of operation comprises an active software-based feature set provided by a vendor, wherein the at least one brand mark is corresponds to the vendor.

4. The multimodal device of claim 2, wherein the set of mode based actuators and indicia presented changes with an active mode of the multimodal device.

5. The multimodal device of claim a, wherein the at least one brand mark changes with an active mode of the multimodal device.

6. The multimodal device of claim 1, wherein the at least one brand mark comprises a logo.

7. The multimodal device of claim 1, wherein the at least one brand mark comprises a company name.

8. The multimodal device of claim 1, wherein the at least one brand mark comprises a slogan.

9. The multimodal device of claim 1, wherein the at least one brand mark comprises a trademark.

10. The multimodal device of claim 1, wherein the multimodal device comprises a radiotelephone, further wherein the at least one brand mark comprises a mark associated with a radiotelephone service provider.

11. The multimodal device of claim 1, wherein the at least one brand mark is multicolored.

12. A portable electronic device comprising a high resolution display having a plurality of individually addressable pixels and a segmented optical shutter device configured to present at least one keypad configuration comprising a non-pixelated brand mark to a user, wherein the segmented optical shutter device traverses a keypad region of the portable electronic device and the high resolution display and is configured to selectively transition segments from an opaque state to a translucent state, wherein the brand mark is presented in the keypad region.

13. The portable electronic device of claim 12, wherein the at least one keypad configuration comprising a brand mark corresponds to an active mode of the portable electronic device.

14. The portable electronic device of claim 13, wherein the active mode of the portable electronic device is one of a gaming mode, a navigation mode, a camera mode, or a media player mode.

15. The portable electronic device of claim 14, wherein the active mode of the portable electronic device is the gaming mode, wherein the brand mark corresponds to an electronic game vendor.

16. The portable electronic device of claim 14, wherein the active mode of the portable electronic device is the media player mode, wherein the brand mark corresponds to an electronic multimedia content vendor.

17. The portable electronic device of claim 12, further comprising a proximity detection device configured to detect objects proximately located with the segmented optical shutter device.

18. The portable electronic device of claim 12, further comprising a luminescent device configured to illuminate the brand mark.

19. The portable electronic device of claim 12, further comprising a resistive force sensor disposed along the keypad region and configured to detect contact with the segmented optical shutter device.

20. The portable electronic device of claim 12, further comprising a set of navigational actuation elements configured to permit selection of an active mode of the portable electronic device.
